(19) United States
(12) Patent Application Publication
(10) Pub. No.: US 2026/0149361 A1
(43) Pub. Date: May 28, 2026

(54) POWER CONVERTER WITH DELAY PERIOD

(71) Applicant: APPLE INC., CUPERTINO, CA (US)

(72) Inventors: PIETRO GABRIELE GAMBETTA, LIVORNO (IT); GABRIELE CAVALLETTI, LUCCA (IT); MASSIMO BERTINI, LIVORNO (IT); SIMONE SILVESTRI, LIVORNO (IT)

(21) Appl. No.: 18/962,548

(22) Filed: Nov. 27, 2024

(51) Int. Cl. H02M 1/32; H02M 1/08; H02M 3/07

(52) U.S. Cl. CPC H02M 1/32; H02M 1/08; H02M 3/07

(57) ABSTRACT

A power converter includes a voltage regulator circuit including a switch node coupled to a regulated power supply node via an inductor. The voltage regulator circuit is configured to source a charge current to the switch node during a charge cycle. The power converter also includes a control circuit. The control circuit is configured to generate a control current using a voltage level of the regulated power supply node and a reference voltage level. The control circuit is also configured to halt the charge cycle for a period of time based on the control current and a sensed inductor current.

### BACKGROUND

### Technical Field

Embodiments described herein relate to integrated circuits, and more particularly, to a power converter with a delay period.

### Description of the Related Art

Modern computer systems may include multiple circuits blocks designed to perform various functions. For example, such circuit blocks may include processors, processor cores configured to execute software or program instructions. Additionally, the circuit blocks may include memory circuits, mixed-signal or analog circuits, and the like.

In some computer systems, the circuit blocks may be designed to operate at different power supply voltage levels. Power management circuits may be included in such computer systems to generate and monitor varying power supply voltage levels for the different circuit blocks.

Power management circuits often include one or more power converter circuits configured to generate regulator voltage levels on respective power supply signals using a voltage level of an input power supply signal. Such regulator circuits may employ multiple passive circuit elements, such as inductors, capacitors, and the like.

### SUMMARY OF VARIOUS EMBODIMENTS

Various embodiments of a power converter circuit are also disclosed. Broadly speaking, a power converter circuit for sourcing a charge current to another device/circuit are contemplated. The power converter circuit may include a delay circuit. The delay circuit may determine an adaptive/adjustable delay (e.g., an adjustable/adaptive delay period) for extending a discharge cycle of a power converter circuit (e.g., may extend the end of a discharge cycle for the delay period). The delay circuit may use one or more capacitors to determine the delay period. The delay period may be based on a target average current for the power converter circuit.

### BRIEF DESCRIPTION OF THE DRAWINGS

The following detailed description makes reference to the accompanying drawings, which are now briefly described.

FIG. 1 illustrates a diagram of an example power converter circuit, in accordance with one or more embodiments of the present disclosure.

FIG. 2 illustrates a diagram of an example voltage regulator circuit, in accordance with one or more embodiments of the present disclosure.

FIG. 3 illustrates a block diagram of an example control circuit for a power converter circuit, in accordance with one or more embodiments of the present disclosure.

FIG. 4 illustrates a block diagram of an example delay circuit, in accordance with one or more embodiments of the present disclosure.

FIG. 5 illustrates a block diagram of an example delay circuit, in accordance with one or more embodiments of the present disclosure.

FIG. 6 illustrates a flow diagram depicting an embodiment of a method for operating a power converter circuit, in accordance with one or more embodiments of the present disclosure.

FIG. 7 illustrates a block diagram of an example computer system, in accordance with one or more embodiments of the present disclosure.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF EMBODIMENTS

Computer systems may include multiple circuit blocks configured to perform specific

functions. Such circuit blocks may be fabricated on a common substrate and may employ different power supply voltage levels. Power management units (commonly referred to as “PMUs”) may include multiple power converter circuits configured to generate regulated voltage levels for various power supply signals. Such power converter circuits may employ a regulator circuit that includes both passive circuit elements (e.g., inductors, capacitors, etc.) as well as active circuit elements (e.g., transistors, diodes, etc.).

Different types of voltage regulator circuits may be employed based on power requirements of load circuits, available circuit area, and the like. One type of commonly used voltage regulator circuit is a buck converter circuit. Such buck converter circuits include multiple devices and a switch node that is coupled to a regulated power supply node via an inductor and/or other circuit used to sense/measure current. Particular ones of the multiple devices are then activated to periodically charge and discharge the switch node in order to maintain a desired voltage level on power supply node. In some embodiments, the period of time one or more of the multiple devices are activated to enable charging the switch node, is referred to as a charge cycle. The charge cycle may have a fixed or variable period, relative to a subsequent charge cycle. In some embodiments, the period of time one or more of the multiple devices are activated to disable charging the switch node, is referred to as a discharge cycle. The discharge cycle may have a fixed or variable period, relative to a subsequent discharge cycle.

To determine the duration of either the charge cycle or discharge cycle, current mode control may be used in some power converter circuits in order to provide a desired transient response of the power converter circuit as well as balance currents in multi-phase power converter circuits. In a power converter circuit using current mode control, control circuits may generate a control current whose values is based, at least in part, on a comparison of a voltage level of the regulated power supply node and a reference voltage. The control current may then be compared to a current that is flowing to an output of the power converter circuit to determine the duration of the charge or discharge cycle.

It may be useful for the power converter circuit to maintain a target average current (e.g., a target average output current) during certain modes of operation. For example, while operating in a lower power or minimum power mode, it may be useful for the power converter circuit to maintain an average output current of zero or nearly zero (e.g., to have an average output current of zero). However, even in a low/minimum power mode the power converter circuit may generate a positive current. For example, a power converter circuit may be generating current for a minimum amount of time, even if the power converter circuit is operating in the lower/minimum power mode. Thus, the power converter circuit may have an average output current that is positive, rather than an average output current of zero (or close to zero).

The embodiments illustrated in the drawings and described below may provide techniques for operating a control circuit that may include a delay circuit for delaying an end of the discharge cycle. For example, the delay circuit may determine a delay period (e.g., an amount of time) for delaying the end of the discharge cycle (e.g., may extend the discharge cycle for the delay period/time and/or may delay the start of a next charge cycle). During a discharge cycle, the voltage representing/indicative of the current (generated by the power converter circuit) may decrease. When the voltage representing the current reaches 0V (e.g., after the current provided by the power converter circuit reaches 0 amps), the discharge cycle is extended by the delay period. This may allow the average of the current generated by the power converter circuit to be zero (or close to zero), as discussed in more detail below.

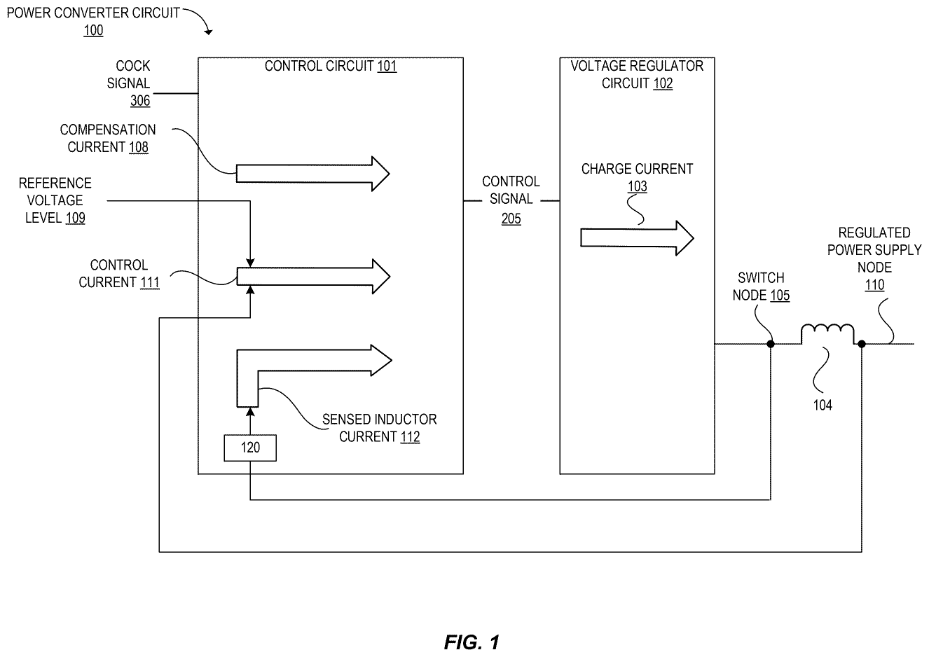

FIG. 1 illustrates a block diagram of an example power converter circuit, in accordance with one or more embodiments of the present disclosure. As illustrated, power converter circuit 100 includes control circuit 101, voltage regulator circuit 102, and delay circuit 120.

Output of voltage regulator circuit 102 includes is coupled to an inductor 104 at switch node 105. In various embodiments, voltage regulator circuit 102 is configured, in response to an initiation of charge cycle through control signal 205, to source charge current 103 to switch node 105. It is noted that although a single voltage regulator circuit is depicted in the embodiment of FIG. 1, in other embodiments, multiple voltage regulator circuits (collectively “phase units” or “phase circuits”) may be coupled to regulated power supply node 110, in parallel, and operated with different timings (or “phases”). Additionally, it is noted that inductor 104 may be implemented as a standalone, off-chip component or on-chip as a component of voltage regulator circuit 102. In some embodiments, inductor 104 comprises one or more inductors coupled in series. In some embodiments, inductor 104 is implemented on a chiplet electrically coupled to an integrated circuit chip comprising at least a portion of power converter circuit 100A.

The duration of charge and discharge cycles in a power converter circuit may be determined using current control. As illustrated in FIG. 1, control circuit 101 is configured, in response to an initiation of charge cycle, to generate control current 111 using a voltage level of regulated power supply node 110 and reference voltage level 109. In various embodiments, control circuit 101 initiates charge cycle through the control signal 205 in response to an assertion of a clock signal 306 or other signal (e.g., a timing signal).

Control circuit 101 is also configured to generate compensation current 108. In various embodiments, compensation current 108 may be used to perform slope compensation on sensed inductor current 112. Compensation current 108 may be an increasing ramp signal with a fixed slope that is activated in response to the assertion of the clock or other timing signal. As used herein, sensed inductor current 112 is a current that is flowing through inductor 104 during a charge cycle. In various embodiments, sensed inductor current 112 may be inferred from a voltage level of switch node 105, measured using a voltage drop across a resistor in series with inductor 104, or any other suitable circuit or technique.

Control circuit 101 also includes a delay circuit 120. Delay circuit 120 is configured to determine a delay period. The control circuit 101) may control the operation of the power converter circuit 100 based on the delay period. For example, a discharge cycle of the power converter circuit 100 may be extended by the delay period (e.g., the start of a next charge cycle may be delayed by the delay period), as discuss in more detail below.

Although the delay circuit 120 is illustrated as part of the control circuit 101, the delay circuit 120 may be part of other circuits in other embodiments. For example, the delay circuit 120 may be part of the voltage regulator circuit 102. In another example, the delay circuit 120 may be a circuit that is separate from both the control circuit 101 and the voltage regulator circuit 102. The delay circuit 120 is discussed in more detail below.

In addition to generating compensation current 108, control circuit 101 is also configured to halt and/or start charge cycle using control current 111, sensed inductor current 112, and compensation current 108. In various embodiments, control circuit may combine sensed inductor current 112 and compensation current 108, and compare the combined current to control current 111.

As discussed above, the power converter circuit 100 uses the current flowing to the regulated power supply node 110 (e.g., and output of the power converter circuit 100) to determine the duration of the charge cycle. Sensing the amount of current flowing to the output of the power converter circuit more accurately may allow the power converter circuit 100 to operate more efficiently, use/waste less power, to generate less heat, etc.

It may be useful or desirable for a power converter circuit 100 to have an average output current that matches or is within a range/threshold of a target output average current (e.g., a desired average output current, a target average output current, etc.). For example, other circuits, devices, components, etc., coupled to the power converter circuit 100 may require, desire, prefer, etc., a target average output current for the power converter circuit. In another example, it may be useful or desirable for the power converter circuit 100 to have an average output current of zero (or close to zero) while the power converter circuit is operating in the certain modes (e.g., low power/current mode). The embodiments, implementations, and/or examples described herein may provide techniques for operating a control circuit 101 that may include a delay circuit. The delay circuit may delay the end of a discharge cycle to allow the power converter circuit 100 to generate an average output current that matches or is within a range/threshold of the target average output current, as discussed in more detail below.

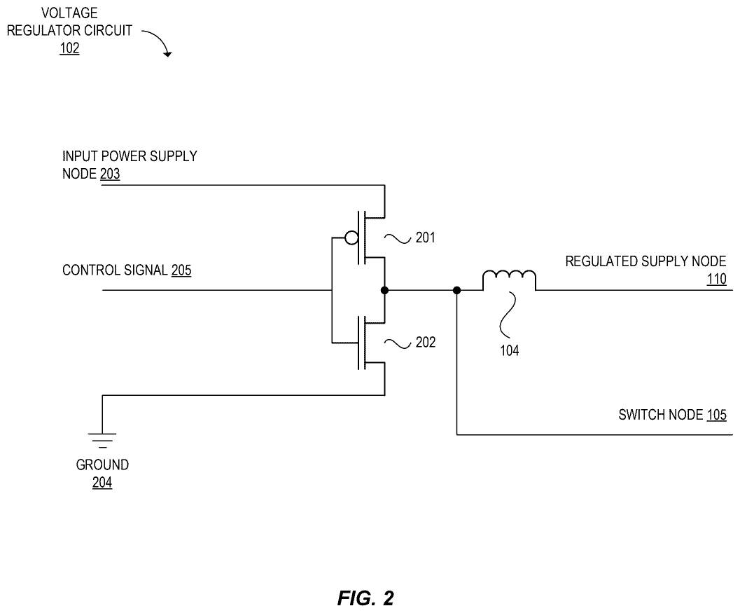

FIG. 2 illustrates a diagram of an example voltage regulator circuit 102, in accordance with one or more embodiments of the present disclosure. Voltage regulator circuits, such as voltage regulator circuit 102, may be designed according to one of various design styles. A schematic diagram of a particular embodiment of voltage regulator circuit 102 is depicted in FIG. 2. As illustrated, voltage regulator circuit 102 includes devices 201 and 202, which are both coupled to switch node 105, and controlled by control signal 205. In some embodiments, device 201 and device 202 are voltage controlled devices, to switch or amplify electrical signals or power. In some embodiments, device 201 and device 202 are current controlled devices, to switch or amplify electrical signals or power.

In various embodiments, control circuit 101 may generate control signal 205, which is used to activate one of devices 201 and 202 during charge and discharge cycles. During a charge cycle, current increases and is sourced from input power supply node 203 to regulated power supply node 110, and during a discharge cycle, current is decreased and is sourced from ground supply node 204 into regulated power supply node 110. Alternating between charge and discharge cycles, and adjusting the duration of either of the charge or discharge cycles may maintain a desired voltage level on regulated power supply node 110.

Device 201 is coupled between input power supply node 203 and switch node 105, and is controlled by control signal 205. During a charge cycle, control signal 205 is asserted, which activates device 201 and couples input power supply node 203 to switch node 105, thereby charging switch node 105 by allowing a current to flow from input power supply node 203 to switch node 105, and then onto regulated power supply node 110. As described below in more detail, the duration of the charge cycle may be based on a comparison of a generated current to a combination of generated and sensed currents.

In one embodiment, the switch node 105 may be coupled to delay circuit 120. The delay circuit 120 may measure, sense, or detect the current flowing through the regulated power supply node 110, as discussed in more detail below.

As used herein, asserting, or an assertion of, a signal refers to setting the signal to a particular voltage level that activates a circuit or device coupled to the signal. The particular voltage level may be any suitable value. For example, in the case where device 201 is p-channel MOSFET, control signal 205 may be set to a voltage at or near ground potential when activated.

Device 202 is coupled between switch node 105 and ground supply node 204, and is also controlled by control signal 205. During a discharge cycle, control signal 205 is set to a voltage level, which activates device 202 and couples switch node 105 to ground supply node 204, thereby providing a conduction path from regulated power supply node 110 through inductor 104 into ground supply node 204. While device 202 is active, current flows from regulated power supply node 110 into ground supply node 204,.

Device 201 and device 202 may be particular embodiments of MOSFETs. In particular, device 201 may be a particular embodiment of a p-channel MOSFET and device 202 may be a particular embodiment of an n-channel MOSFET. Although only two devices are depicted in the embodiment of FIG. 2, in other embodiments, any suitable number of devices, coupled in series or parallel, may be employed to achieve particular electrical characteristics (e.g., on-resistance of the devices).

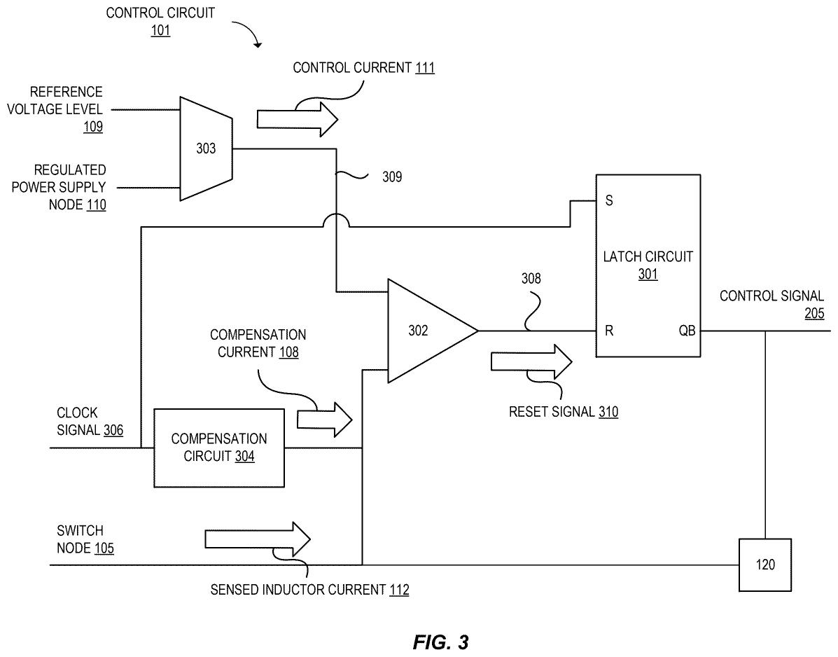

FIG. 3 illustrates a block diagram of an example control circuit 101 for a power converter circuit, in accordance with one or more embodiments of the present disclosure. As illustrated, control circuit 101 includes latch circuit 301, comparator circuit 302, comparator circuit 303, and compensation circuit 304.

Latch circuit 301 may be a particular embodiment of a Set-Reset (SR) latch configured to set control signal 205 to a low logic value in response to an assertion of clock signal 306. Additionally, Latch circuit 301 is configured to set control signal 205 to a high logic level in response as assertion of reset signal 310 on node 308.

Latch circuit 301 may be designed according to one of various design styles. In various embodiments, latch circuit 301 may include multiple logic gates, such as, cross-coupled NAND gates, or any other suitable combination of logic gates and/or MOSFETs to implement the functionality described above.

Comparator circuit 302 is coupled to latch circuit 301 via node 308, and may be a particular embodiment of a differential amplifier configured to generate reset signal 310 on node 308 using control current 111 and a combination of compensation current 108, and sensed inductor current 112. In various embodiments, comparator circuit 302 may be configured to set reset signal 310 to a particular digital voltage level using results of comparing control current 111 to the combination of compensation current 108, and sensed inductor current 112. For example, when a value of control current 111 is substantially the same as the combination of compensation current 108, and sensed inductor current 112, comparator circuit 302 may set the voltage level of reset signal 310 to a voltage level corresponding to a high logic level.

Comparator circuit 303 is coupled to comparator circuit 302 via node 309, and may be a particular embodiment of a transconductance amplifier configured to generate control current 111 in node 309. The value of control current 111 may be based, at least in part, on a comparison of reference voltage level 109 and the voltage level of regulated power supply node 110. In various embodiments, comparator circuit 303 may amplify a difference between reference voltage level 109 and the voltage level of regulated power supply node 110, and convert the difference in voltage levels to control current 111.

Compensation circuit 304 is coupled to clock signal 306 and switch node 105, and is configured to generate compensation current 108. In various embodiments, compensation circuit 304 is configured to generate compensation current 108 in response to an assertion of clock signal 306. Compensation circuit 304 may be further configured to source (or add) compensation current 108 to sensed inductor current 112 to generate a sum of the two currents. Switch node 105 is also coupled to delay circuit 120. The delay circuit 120 may delay the end of a discharge cycle to allow the power converter circuit 100 to generate an average output current that matches or is within a range/threshold of the target average output current, as discussed in more detail below. For example, the delay circuit 120 may provide signals (e.g., a control signal), messages, etc., to the voltage regulator circuit 102 to control operation of the devices 202 and/or 201 (e.g., to turn off the device 202).

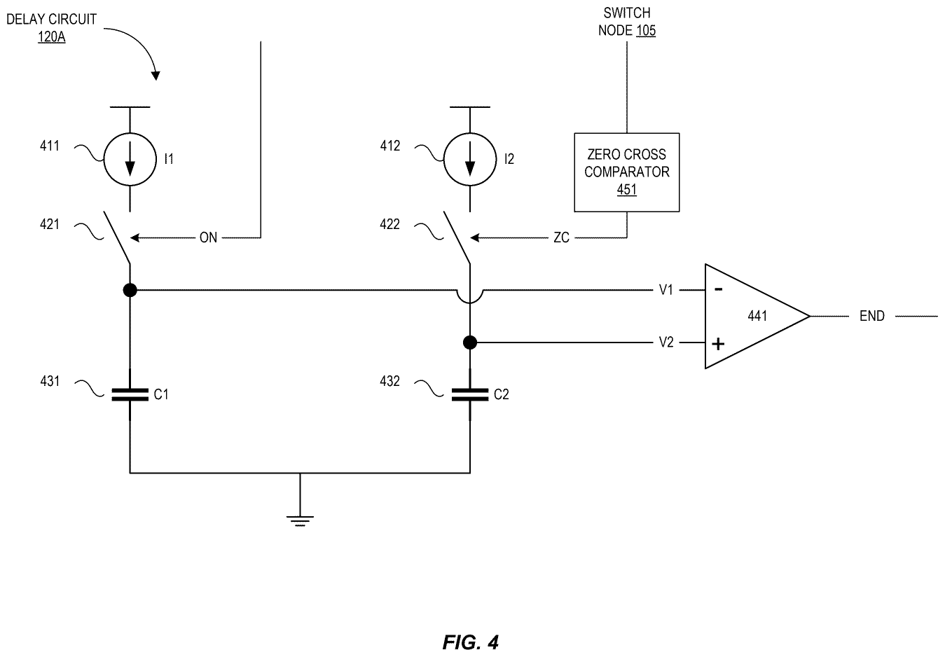

FIG. 4 illustrates a block diagram of an example delay circuit 120A, in accordance with one or more embodiments of the present disclosure. Managing, controlling, etc., the operation of a power converter circuit (e.g., power converter circuit 100 illustrated in FIG. 1) may be accomplished using a variety of circuit designs. Delay circuit 120A may be a particular embodiment of delay circuit 120 (illustrated in FIGS. 1-3) that may be used to control and/or help control the operation of the power converter circuit 100. As illustrated, delay circuit 120A includes a current source 411, a current source 412, a switch 421, a switch 422, a capacitor 431, a capacitor 432, a comparator 441, and a zero cross comparator 451.

In one embodiment, it may useful or desirable for the power converter circuit 100 to have an average output current that matches or is within a range/threshold a target average output current (e.g., a desired average output current). For example, it may be useful or desirable for the power converter circuit 100 to have an average current of zero (or within a range of zero) while the power converter circuit is operating in the low power/current mode. The power converter circuit 100 may not be able to operate for a period of time that is smaller/less than the minimum on time. For example, the power converter circuit 100 must convert power/current for at least the minimum on time during a charge cycle. In addition, the power converter circuit 100 may generate a positive current in the low power/current mode due to the minimum on time. Thus, to maintain an average output current that matches or is within a range/threshold a target average output current (e.g., zero current), the delay circuit 120A may delay the start of a next charge cycle (e.g., extend the time for the current discharge cycle) based on one or more of the minimum on time, V_{IN} (e.g., an input voltage), and V_{OUT} (e.g., an output voltage).

In one embodiment, the delay circuit 120A may provide current limitation functions that may help prevent the average output current from going below zero (or beyond a certain range below zero), using the zero cross comparator 451 (e.g., without using additional direct sensing circuitry to detect the average output current or valley/low point in current). In addition, when the load of the power converter circuit 100 is zero amps (or close to zero amps), the power converter circuit 100 may still continue regulating the output voltage and may prevent the current from being pushed to the input and while maintaining a fixed switching frequency.

Capacitors 431 and 432 may be circuits, devices, and/or any other appropriate component that stores electrical energy or charge. Capacitor 431 may have a capacitance of C1 and capacitor 432 may have a capacitance of C2. In some embodiments, capacitance C1 may be the same (or substantially the same) as capacitance C2. In other embodiments, capacitance C1 may be different from capacitance C2 (e.g., capacitance C1 may be greater than capacitance C2 or vice versa). One or more the capacitors 431 and 432 may be adjustable or configurable capacitors. An adjustable/configurable capacitor may allow the capacitance of the capacitor to be changed, modified, adjusted, etc.

Switches 421 and 422 may be circuits, devices, field-effect transistors (FETS), and/or any other appropriate component that allows/prevents current from flowing through the switches 421 and 422. Each of switches 421 and 422 may be controlled by a control signal (or some other appropriate signal, message, etc.). For example, a first control signal may be used to turn on switch 421 (e.g., allow current to flow through switch 421) or turn off switch 421 (e.g., prevent current from flowing through switch 421). In another example, a second control signal may be used to turn on switch 422 and turn off switch 422.

In one embodiment, the current source 411 generates a first current that flows to the capacitor 431 via the switch 421 (e.g., when the switch 421 is closed or connected). The control/operation of the switch 421 is discussed in more detail below. The first current may be referred to as I1. The current I1 may be proportional to and/or based on the voltages V_{IN} and V_{OUT}, the input voltage and output voltage of the power converter circuit. In particular, the first current I1 may be proportional to and/or based on V_{IN}−V_{OUT}. The current source 412 may be used to charge the capacitor 431.

In one embodiment, the switch 421 may be controlled by an ON signal (e.g., a first control signal). The ON signal may indicate when the power converter circuit 100 is providing/generating power and/or current. For example, the ON signal may remain high (e.g., a logical 1, at a high voltage, etc.) while the power converter circuit 100 is generating current/power and may go low (e.g., a logical 0, a low voltage, etc.) when the power converter circuit 100 is not generating current/power. The ON signal may be based on the start/halt signal illustrated in FIG. 1.

When the ON signal is high (e.g., when the power converter circuit 100 is operating or converting current/power), the switch 421 may be turned on, allowing current to flow from the current source 412 to the capacitor 431. For example, the capacitor 431 may start charging at the beginning of the charge cycle. When the ON signal is low (e.g., when the power converter circuit 100 is not generating current/power), the switch 421 may be turned off, preventing current from flowing to the capacitor 431.

In one embodiment, the current source 412 generates a second current that flows to the capacitor 432 via the switch 422 (e.g., when the switch 422 is closed or connected). The control/operation of the switch 422 is discussed in more detail below. The second current may be referred to as I2. The current I2 may be proportional to and/or based on the voltage V_{OUT}. The current source 412 may be used to charge the capacitor 432.

In one embodiment, the zero cross comparator 451 is an example of a low voltage threshold comparator. A low voltage threshold comparator may be a circuit, device, or any other appropriate component that determines when a voltage at an input of the comparator crosses a particular low voltage threshold. A zero cross comparator compares an input voltage to a low voltage threshold of zero or nearly zero volts. Said another way, a zero cross comparator may detect a change from a positive voltage to a negative voltage and/or vice versa. For example, the zero cross comparator 451 may determine when a voltage changes from positive to negative (e.g., when the voltage crosses over 0V from a positive voltage to a negative voltage). In another example, the zero cross comparator 451 may determine when a voltage changes from negative to positive (e.g., when the voltage crosses over 0V from a negative voltage to a positive voltage). Although the present disclosure may refer to 0V for the zero cross comparator 451, another threshold voltage may be used in other embodiments. For example, the zero cross comparator 451 may be used to determine when the voltage crosses from greater than a threshold voltage (e.g., 0.5V) to lower than the threshold voltage and/or vice versa.

In one embodiment, the zero cross comparator 451 may be coupled to the switch node 105 (illustrated in FIGS. 1-3). The zero cross comparator 451 may determine when the voltage at the switch node 105 crosses 0V (e.g., crosses or goes through 0V from a positive voltage to a negative voltage, or crosses some other appropriated threshold voltage). The zero cross comparator 451 may generate a signal ZC (or may generate some other appropriate message/indication) when the voltage at the switch node 105 crosses 0V. The signal ZC is provided to the switch 422.

In one embodiment, the switch 422 may be managed, controlled, etc., based on and/or by the signal ZC (e.g., a second control signal) generated by the zero cross comparator 451. For example, if the signal ZC is a high (e.g., a logical high, a high voltage, etc.), the switch 422 may be turned on (e.g., may allow the current from current source 412 to flow to the capacitor 432). In another example, if the signal ZC is a low (e.g., a logical low, a low voltage, etc.), the switch 422 may be turned off (e.g., may prevent the current from current source 412 from flowing to the capacitor 432).

The period of time that the power converter circuit 100 is operating or converting current/power (e.g., the time period of the charge cycle) may be referred to as an on time, on period, active time, active period, a charge time, a charge cycle time, etc. In one embodiment, the power converter circuit 100 may operate in a low current/power mode (e.g., a low power mode, a minimum current mode, a low current mode, a minimum current mode, etc.). While operating in the low current/power mode, the power converter circuit 100 may have and/or use a minimum on time. A minimum on time may refer to a minimum amount of time that the power converter circuit 100 should generate power/current (e.g., the minimum time period or amount of time for a charge cycle). The minimum on time may be used when other devices (e.g., other circuits and/or components) are using or are requesting little to no current/power from the power converter circuit 100.

As discussed above, switch 421 may be turned on when the ON signal is received (e.g., when power converter circuit 100 operates or converts power/current or when the power converter circuit 100 is in the charge cycle). While the power converter circuit 100 operates or converts power/current during the minimum on time (e.g., during a minimum charge cycle), the first current I1 may flow from current source 411 to capacitor 431 and to charge the capacitor 431. The first current I1 may be proportional to and/or based on V_{IN}−V_{OUT}. During the minimum on time, the voltage V1 of the capacitor 431 may increase.

In one embodiment, the delay circuit 120A may allow the power converter circuit 100 to achieve or have an average output current that is equal to or within a range of target average output current, such as zero current. For example, charging the capacitors 431 and 432 based on the ON and ZC signals may allow the delay circuit 120A to control/manage the charge/discharge cycles of the power converter circuit 100 to have an average output current (e.g., the average output current of a charge cycle and a discharge cycle) that is equal to or within a range of a target average output current (e.g., zero current), as discussed in more detail below.

After the minimum on time is completed (e.g., finishes, passes, etc.), the power converter circuit 100 may halt the charge cycle and may start a discharge cycle. During the discharge cycle, the current generated by the power converter circuit 100 may drop or decrease to zero and the voltage representing the current may also reach zero. Although the current of the power converter circuit 100 may drop to zero during the discharge cycle, the average output current of the power converter circuit 100 may remain positive, because the power converter circuit 100 was generating a positive current during the minimum on time.

In one embodiment, the delay circuit 120 may delay the end of the discharge cycle of the power converter circuit 100 until the voltage V2 of the capacitor 432 matches the voltage V1 of the capacitor 431. For example, the zero cross comparator 451 may detect when the voltage representing the current reaches (e.g., crosses) zero, as discussed above. When the voltage representing the current reaches zero, the zero cross comparator 451 generates the signal ZC which turns on the switch 421. This allows the second current I2 to flow from current source 412 to the capacitor 432. The current I2 may be proportional to and/or based on V_{OUT}, as discussed above. As the second current I2 flows to the capacitor 432, the voltage V2 of the capacitor 432 increases/rises. The comparator 441 compares the voltage V1 with the voltage V2 and may generate an END signal (e.g., a stop signal, a halt signal, etc.) when the voltage V1 matches the voltage V2.

During the time that the voltage V2 increased to match the voltage V1, the power converter circuit 100 may continue the discharge cycle. For example, the end of the discharge cycle is delayed until the voltage V2 increases to match the voltage V1. The amount of time for the voltage V2 to match the voltage V1 maybe referred to as a delay period, a delay time, etc.

Because the current has already reached zero when the zero cross comparator 451 generates the ZC signal, delaying the end of the discharge cycle (for the delay period) allows the current of the power converter circuit 100 to decrease below zero and go negative. The rate of increase and/or decrease in the current may depend on the voltages V_{IN} and V_{OUT} of the power converter circuit 100. In one embodiment, the rate of decrease in the current (of the power converter circuit 100) during the discharge cycle may be equal or close to the rate of increase in the current (of the power converter circuit 100) during the minimum on time.

In one embodiment, the delay period/time may be based on the target average output current (e.g., an average output current of 0, a desired average output current, etc.). For example, the capacitance of capacitor 431 may be equal to the capacitance of the capacitor 432, as discussed above. Thus, the amount of time for the voltage V2 (of the capacitor 432) to increase to match the voltage V1 (of the capacitor 431) may be equal to (or close to) the minimum on time. During the amount of time for voltage V2 to match the voltage V1, the power converter continues with the discharge cycle until the current reaches a (negative) valley equal (or substantially equal) in absolute value to the (positive) peak reached at the end of the minimum on-time. This may allow the average output current generated by the power converter circuit 100 to be equal to (or substantially equal to) zero current (e.g., a target average output current). In some embodiments, the amount of time for V2 to rise and match V1 may be different than the minimum on-time depending on V_{IN} and V_{OUT}. This amount of time (t) may be represented as follows: t=minOn*((V_{IN}−V^{OUT})/V_{OUT}), where minOn represents the minimum on-time.

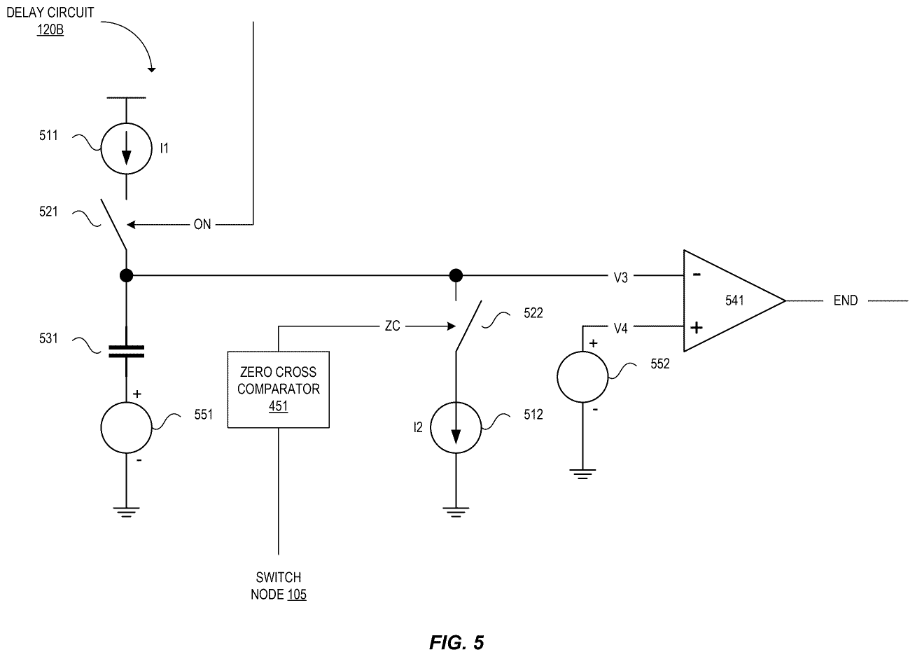

FIG. 5 illustrates a block diagram of an example delay circuit 120B, in accordance with one or more embodiments of the present disclosure. Managing, controlling, etc., the operation of a power converter circuit (e.g., power converter circuit 100 illustrated in FIG. 1) may be accomplished using a variety of circuit designs. Delay circuit 120B may be a particular embodiment of delay circuit 120B (illustrated in FIGS. 1-3) that may be used to control and/or help control the operation of the power converter circuit 100. As illustrated, delay circuit 120B includes a current source 511, a current source 512, a switch 521, a switch 522, a capacitor 531, a voltage source 551, a voltage source 552, a comparator 541, and a zero cross comparator 451.

As discussed above, it may useful or desirable for the power converter circuit 100 to have an average output current that matches or is within a range/threshold a target average output current (e.g., a current of zero). To operate/function correctly, the power converter circuit 100 may need to convert power/current for at least the minimum on time during a charge cycle and may generate a positive current in the low power/current mode due to the minimum on time. Thus, to maintain an average output current that matches or is within a range/threshold a target average output current (e.g., zero current), the delay circuit 120B may delay the start of a next charge cycle (e.g., extend the time for the current discharge cycle) based on one or more of the minimum on time, V_{IN} (e.g., an input voltage), and V_{OUT} (e.g., an output voltage). The delay circuit 120B may also provide current limitation functions that may help prevent the average output current from going below zero (or beyond a certain range below zero), using the zero cross comparator 451 (e.g., without using additional direct sensing circuitry to detect the average output current or valley/low point in current), as discussed above.

Capacitor 531 may be circuits, devices, and/or any other appropriate component that stores electrical energy or charge. Capacitor 531 may be an adjustable/configurable capacitor. Switches 521 and 522 may be circuits, devices, field-effect transistors (FETS), and/or any other appropriate component that allows/prevents current from flowing through the switches 521 and 522. Each of switches 521 and 522 may be controlled by a control signal (e.g., to turn switches 521 and 522 on/off).

In one embodiment, the current source 511 generates a first current I1 that flows to the capacitor 531 via the switch 521. The control/operation of the switch 521 is discussed in more detail below. The current I1 may be proportional to and/or based on the voltages may be proportional to and/or based on V_{IN}−V_{OUT}. The current source 512 may be used to charge the capacitor 531.

In one embodiment, the switch 521 may be controlled by an ON signal (e.g., a first control signal). The ON signal may indicate when the power converter circuit 100 is providing/generating power and/or current, as discussed above. When the ON signal is high, the switch 521 may be turned on, allowing current to flow from the current source 512 to the capacitor 531, charging the capacitor 531. For example, the capacitor 531 may start charging at the beginning of the charge cycle. When the ON signal is low (, the switch 521 may be turned off, preventing current from flowing to the capacitor 531.

In one embodiment, the voltage source 551 may be used to charge (e.g., pre-charge) the capacitor 531 to a certain voltage. For example, the voltage source 551 may allow the voltage of the capacitor 531 to start at the certain voltage. The voltage source 551 may be an optional component of the delay circuit 120B. The voltage source 552 may provide a threshold voltage V4 to the comparator 541. The threshold voltage V4 may be used to determine when the discharge cycle for the power converter circuit 100 should end, as discussed in more detail below.

In one embodiment, the current source 512 generates a second current that flows to the ground. The current source 512 may be used to discharge the capacitor 531. The control/operation of the switch 522 is discussed in more detail below. The second current may be referred to as I2. The current I2 may be proportional to and/or based on the voltage V_{OUT}.

In one embodiment, the zero cross comparator 541 may be a circuit, device, or any other appropriate component that determines when a voltage changes from a positive voltage to a negative voltage and/or vice versa. The zero cross comparator 541 may be coupled to the switch node 105 (illustrated in FIGS. 1-3). The zero cross comparator 541 may determine when the voltage at the switch node 105 crosses 0V. The zero cross comparator 541 may generate a signal ZC when the voltage at the switch node 105 crosses 0V. The signal ZC is provided to the switch 522.

In one embodiment, the switch 522 may be managed, controlled, etc., based on and/or by the signal ZC generated by the zero cross comparator 541. For example, if the signal ZC is a high, the switch 522 may be turned on. In another example, if the signal ZC is a low, the switch 522 may be turned off.

In one embodiment, the delay circuit 120B may allow the power converter circuit 100 to achieve or have an average current that is equal to or within a range of target average output current, such as zero current. For example, charging and discharging the capacitor 531 based on the ON and ZC signals may allow the delay circuit 120B to control/manage the charge/discharge cycles of the power converter circuit 100 to have an average output current (e.g., the average output current of a charge cycle and a discharge cycle) that is equal to or within a range of a target average output current (e.g., zero current), as discussed in more detail below.

As discussed above, switch 521 may be turned on when the ON signal is received (e.g., when power converter circuit 100 generates power/current or when the power converter circuit 100 is in the charge cycle). While the power converter circuit 100 generating power/current during the minimum on time (e.g., during a minimum charge cycle), the first current I1 may flow from current source 511 to capacitor 531 and to charge the capacitor 531. The first current I1 may be proportional to and/or based on V_{IN}−V_{OUT}, as discussed above. During the minimum on time, the voltage V3 of the capacitor 531 may increase.

After a period of time (e.g., after the minimum on time), the power converter circuit 100 may halt the charge cycle and may start a discharge cycle after the minimum on time is completed (e.g., finishes, passes, etc.). Although the current of the power converter circuit 100 may drop to zero during the discharge cycle, the average output current of the power converter circuit 100 may remain positive, because the power converter circuit 100 was generating a positive current during the minimum on time.

In one embodiment, the delay circuit 120 may delay the end of the discharge cycle of the power converter circuit 100 until the voltage V3 of the capacitor 531 matches threshold voltage V4 (generated by the voltage source 552). For example, the zero cross comparator 541 may detect when the voltage representing the current reaches (e.g., crosses) zero, as discussed above. When the voltage representing the current reaches zero, the zero cross comparator 541 generates the signal ZC which turns on the switch 522. This allows the second current I2 to flow from current source 512 to ground and discharge the capacitor 531. The current I2 may be proportional to and/or based on V_{OUT}, as discussed above. As the second current I2 flows to ground, the voltage V3 of the capacitor 531 may decrease. The comparator 541 may compare the voltage V3 with the voltage V4 and may generate an END signal (e.g., a stop signal, a halt signal, etc.) when the voltage V3 matches the voltage V4.

During the time that the voltage V3 decreased to match the voltage V4, the power converter circuit 100 may continue the discharge cycle. For example, the end of the discharge cycle is delayed until the voltage V3 decreases to match the voltage V4. The amount of time for the voltage V3 to match the voltage V4 maybe referred to as a delay period, a delay time, etc.

Because the current has already reached zero when the zero cross comparator 541 generates the ZC signal, delaying the end of the discharge cycle (for the delay period) allows the current of the power converter circuit 100 to decrease below zero and go negative. The rate of decrease in the current (of the power converter circuit 100) during the discharge cycle may be equal or close to the rate of increase in the current (of the power converter circuit 100) during the minimum on time.

In one embodiment, the delay period/time may be based on the target average output current (e.g., an average output current of 0, a desired average output current, etc.). For example, the capacitance of capacitor 531 may based on the target average output current, as discussed above. In another example, if another target current (e.g., a non-zero target current is used/selected, the capacitances of the capacitor 531 may be adjusted, changed, modified, etc., to allow the delay circuit 120 to delay the end of a discharge cycle and allow the average output current of the power converter circuit 100 to match the non-zero target average output current.

Structures such as those shown in FIGS. 1-5 for current sensing may be referred to using functional language. In some embodiments, these structures may be described as including “means for initiating a charge cycle of a voltage regulator circuit that includes a switch node coupled to a regulated power supply node via an inductor,” “means for generating a control current using a voltage level of the regulated power supply node and a reference voltage level,” “means for halting the charge cycle for a period of time based on the control current and a sensed inductor current, wherein a portion of the period of time occurs after a voltage of the sensed inductor current reaches a threshold voltage and wherein the period of time is based on a target average output current,” “means for charging a first capacitor of a delay circuit,” “means charging a second capacitor of the delay circuit,” “means for in response to determining that a first voltage of the first capacitor matches a second voltage of the second capacitor, halting the charge cycle,” “means for charging a first capacitor of a delay circuit during the charge cycle,” “means for discharging the first capacitor during a discharge cycle,” and “means for in response to determining that a first voltage of the first capacitor matches a threshold voltage, halting the charge cycle.”

The corresponding structure for “means for initiating a charge cycle of a voltage regulator circuit that includes a switch node coupled to a regulated power supply node via an inductor,” are control circuit 101 and/or delay circuit 120 as well as equivalents of this circuit. The corresponding structure for “means for generating a control current using a voltage level of the regulated power supply node and a reference voltage level” are control circuit 101 and/or delay circuit 120 as well as equivalents of this circuit. The corresponding structure for “means for halting the charge cycle for a period of time based on the control current and a sensed inductor current, wherein a portion of the period of time occurs after a voltage of the sensed inductor current reaches a threshold voltage and wherein the period of time is based on a target average output current” are control circuit 101 and/or delay circuit 120 as well as equivalents of this circuit. The corresponding structure for “means for charging a first capacitor of a delay circuit” are control circuit 101 and/or delay circuit 120 as well as equivalents of this circuit. The corresponding structure for “means charging a second capacitor of the delay circuit” are control circuit 101 and/or delay circuit 120 as well as equivalents of this circuit. The corresponding structure for “means for in response to determining that a first voltage of the first capacitor matches a second voltage of the second capacitor, halting the charge cycle” are control circuit 101 and/or delay circuit 120 as well as equivalents of this circuit. The corresponding structure for “means for charging a first capacitor of a delay circuit during the charge cycle” are control circuit 101 and/or delay circuit 120 as well as equivalents of this circuit. The corresponding structure for “means for discharging the first capacitor during a discharge cycle” are control circuit 101 and/or delay circuit 120 as well as equivalents of this circuit. The corresponding structure for “means for in response to determining that a first voltage of the first capacitor matches a threshold voltage, halting the charge cycle” are control circuit 101 and/or delay circuit 120 as well as equivalents of this circuit.

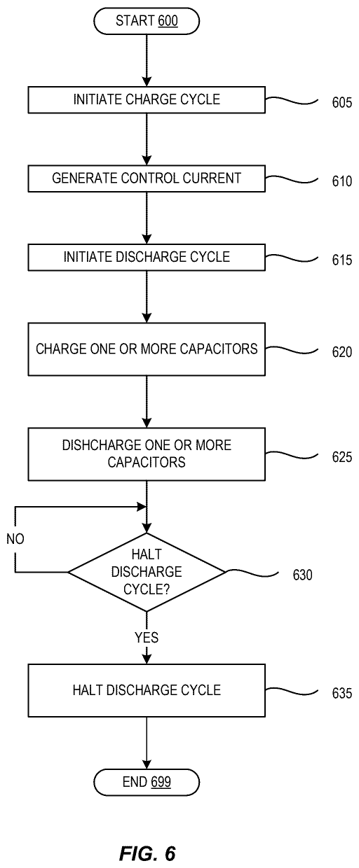

FIG. 6 illustrates a flow diagram depicting an embodiment of a method for operating a power converter circuit, in accordance with one or more embodiments of the present disclosure. The method, which may be applied to one or more of delay circuit 120, control circuit 101, and/or power converter circuit 100 as depicted in FIG. 1, starts at the block 600.

The method includes initiating a charge cycle at block 605. For example, the control circuit 101 and/or power converter circuit 100 may generate a current that may be provided to another circuit/device. At block 610, the method includes generating a control current (which may be referred to as a reference current) using a voltage level of the regulated power supply node and a reference voltage in response to initiating the charge cycle. In some embodiments, the method may include amplifying a difference between the voltage level of the regulated power supply node and the reference voltage level to generate the control current.

The method also includes initiating a discharge cycle at block 615. For example, after a minimum on time/period (or some other appropriate time/period), the discharge cycle may be initiated. In another example, after a threshold current/voltage is reached, the discharge cycle may be initiated.

As discussed above, the discharge cycle may continue for a period of time. The delay circuit 120 may delay the end of the discharge cycle by a delay period. At block 620, the delay circuit 120 may delay the end of the discharge cycle by charging one or more capacitors. For example, referring to FIG. 4, a first capacitor (e.g., capacitor 431) may be charged during the minimum on time and a second capacitor (e.g., capacitor 432) may be charged after the voltage representing the current generated by the power converter circuit cross 0V (or some other appropriate voltage).

At block 625, the method optionally includes discharging one or more capacitors. For example, referring to FIG. 5, when the delay circuit uses a single capacitor (e.g., capacitor 531) for determining how long to delay the end of the discharge cycle (e.g., for determining the delay period), the capacitor may be charged during the minimum on time (e.g., during the charge cycle) and the capacitor may be discharged after the voltage representing the current generated by the power converter circuit cross 0V (or some other appropriate voltage).

The method further includes determining whether to halt the discharge cycle at block 630 (e.g., whether to stop or end the discharge cycle and start the next charge cycle). For example, the delay circuit may determine whether a first voltage of a first capacitor matches a second voltage of a second capacitor. In another example, the delay circuit may determine whether the voltage of a capacitor matches a threshold voltage.

If the discharge cycle should not be halted, the method may continue to block 630. If the discharge cycle should be halted, the method includes halting the discharge cycle at block 635. The method ends at block 699.

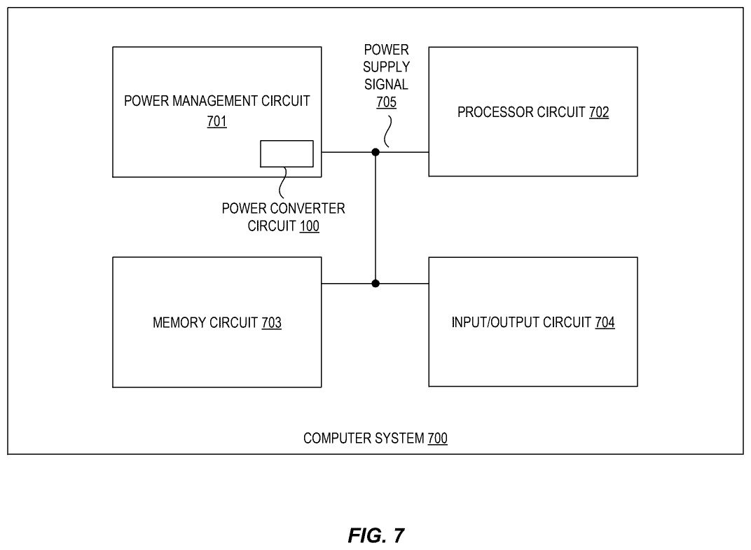

FIG. 7 illustrates a block diagram of an example computer system 700, in accordance with one or more embodiments of the present disclosure. As illustrated in FIG. 7, the computer system 700 includes power management circuit 701, processor circuit 702, memory circuit 703, and input/output circuits 704, each of which is coupled to power supply signal 705. In various embodiments, computer system 700 may be a system-on-a-chip (SoC) and/or be configured for use in a desktop computer, server, or in a mobile computing application such as, e.g., a tablet, laptop computer, or wearable computing device.

Power management circuit 701 includes power converter circuit 100, which is configured to generate a regulated voltage level on power supply signal 705 in order to provide power to processor circuit 702, memory circuit 703, and input/output circuits 704. Although power management circuit 701 is depicted as including a single power converter circuit, in other embodiments, any suitable number of power converter circuits may be included in power management circuit 701, each configured to generate a regulated voltage level on a respective one of multiple internal power supply signals included in computer system 700. In cases where multiple power converter circuits are employed, two or more of the multiple power converter circuits may be connected to a common set of power terminals that connections to power supply signals and ground supply signals of computer system 700.

Processor circuit 702 may, in various embodiments, be representative of a general-purpose processor that performs computational operations. For example, processor circuit 702 may be a central processing unit (CPU) such as a microprocessor, a microcontroller, an application-specific integrated circuit (ASIC), or a field-programmable gate array (FPGA).

Memory circuit 703 may in various embodiments, include any suitable type of memory such as a Dynamic Random-Access Memory (DRAM), a Static Random-Access Memory (SRAM), a Read-Only Memory (ROM), Electrically Erasable Programmable Read-only Memory (EEPROM), or a non-volatile memory, for example. It is noted that although in a single memory circuit is illustrated in FIG. 7, in other embodiments, any suitable number of memory circuits may be employed.

Input/output circuits 704 may be configured to coordinate data transfer between computer system 700 and one or more peripheral devices. Such peripheral devices may include, without limitation, storage devices (e.g., magnetic or optical media-based storage devices including hard drives, tape drives, CD drives, DVD drives, etc.), audio processing subsystems, or any other suitable type of peripheral devices. In some embodiments, input/output circuits 704 may be configured to implement a version of Universal Serial Bus (USB) protocol or IEEE 1394 (Firewire(r)) protocol.

Input/output circuits 704 may also be configured to coordinate data transfer between computer system 700 and one or more devices (e.g., other computing systems or integrated circuits) coupled to computer system 700 via a network. In one embodiment, input/output circuits 704 may be configured to perform the data processing necessary to implement an Ethernet (IEEE 802.3) networking standard such as Gigabit Ethernet or 10-Gigabit Ethernet, for example, although it is contemplated that any suitable networking standard may be implemented. In some embodiments, input/output circuits 704 may be configured to implement multiple discrete network interface ports.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,”or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,”“circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph (f) interpretation for that unit/circuit/component. More generally, the recitation of any element is expressly intended not to invoke 35 U.S.C. § 112, paragraph (f) interpretation for that element unless the language “means for” or “step for” is specifically recited. Should Applicant wish to invoke Section 112(f) during prosecution of a United States patent application based on this disclosure, it will recite claim elements using the “means for” [performing a function] construct.

Different “circuits” may be descried in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a voltage regulator circuit including a switch node coupled to a regulated power supply node via an inductor, wherein the voltage regulator circuit is configured to source a charge current to the switch node during a charge cycle; and
a control circuit configured to:
generate a control current based on a voltage level of the regulated power supply node and a reference voltage level; and
halt the charge cycle for a period of time based on the control current and a sensed inductor current.

2. The apparatus of claim 1, wherein the period of time is a function of a target average output current and the voltage level of the regulated power supply node.

3. The apparatus of claim 1, wherein the control circuit further comprises a delay circuit configured to halt the charge cycle for a portion of the period of time that occurs after a voltage of the sensed inductor current reaches a threshold voltage.

4. The apparatus of claim 3, wherein the delay circuit comprises a zero cross comparator configured to determine when the voltage of the sensed inductor current reaches the threshold voltage.

5. The apparatus of claim 4, wherein the delay circuit further comprises a first capacitor and a second capacitor.

6. The apparatus of claim 5, wherein the first capacitor is charged at a beginning of the charge cycle and the second capacitor is charged when the voltage of the sensed inductor current reaches the threshold voltage.

7. The apparatus of claim 6, wherein the period of time ends when a first voltage of the first capacitor matches a second voltage of the second capacitor.

8. The apparatus of claim 4, wherein the delay circuit further comprises a capacitor and a voltage source.

9. The apparatus of claim 8, wherein the capacitor is charged at a beginning of the charge cycle and is discharged when the voltage of the sensed inductor current reaches a threshold voltage.

10. The apparatus of claim 9, wherein the period of time ends when a voltage of the capacitor matches a threshold voltage.

11. A method, comprising:
initiating a charge cycle of a voltage regulator circuit that includes a switch node coupled to a regulated power supply node via an inductor; and
generating a control current based on a voltage level of the regulated power supply node and a reference voltage level; and
halting the charge cycle for a period of time based on the control current and a sensed inductor current.

12. The method of claim 11, wherein the period of time is a function of a target average output current and the voltage level of the regulated power supply node.

13. The method of claim 11, wherein halting the charge cycle comprises:
charging a first capacitor of a delay circuit; and
charging a second capacitor of the delay circuit, wherein a portion of the period of time ends when a first voltage of the first capacitor matches a second voltage of the second capacitor.

14. The method of claim 13, wherein the first capacitor is charged during the charge cycle.

15. The method of claim 13, wherein the second capacitor is charged during a discharge cycle.

16. The method of claim 11, wherein halting the charge cycle comprises:
charging a first capacitor of a delay circuit during the charge cycle; and
discharging the first capacitor during a discharge cycle, wherein a portion of the period of time ends when a first voltage of the first capacitor matches a threshold voltage.

17. A power converter circuit comprising:
a voltage regulator circuit coupled to an inductor through a switch node; and
a delay circuit comprising:
a first current source coupled to a first input of a first comparator through a first switch and also coupled to ground through the first switch and a first capacitor, wherein the first switch is closed when the inductor is charging;
a second current source coupled to a second input of the first comparator through a second switch and also coupled to ground through the second switch and a second capacitor; and
a second comparator configured to close the second switch when voltage at the switch node crosses a threshold,
wherein the first comparator is configured to delay discharging the inductor until a voltage at the second input matches a voltage at the first input.

18. The power converter circuit of claim 17, wherein the second comparator comprises a low voltage threshold cross comparator configured to determine when a voltage at the switch node crosses a low voltage threshold.

19. The power converter circuit of claim 18, wherein the first capacitor is charged at a beginning of a charge cycle of the inductor and the second capacitor is charged when the voltage at the switch node crosses the low voltage threshold.

20. The power converter circuit of claim 17, wherein the first current source represents a difference between input voltage and output voltage of the power converter circuit and the second current source represents the output voltage of the power converter circuit.
